(19) United States
(12) Patent Application Publication
(10) Pub. No.: US 2025/0233485 A1
(43) Pub. Date: Jul. 17, 2025

(54) ELECTRIC DRIVE DEVICE

(71) Applicant: HONDA MOTOR CO., LTD., Tokyo (JP)

(72) Inventors: Naoki KAMIMURA, Saitama (JP); Tatsunoshin ISHIKAWA, Saitama (JP)

(21) Appl. No.: 18/974,205

(22) Filed: Dec. 9, 2024

(30) Foreign Application Priority Data
Jan. 17, 2024 (JP) 2024-005633

(51) Int. Cl. H02K 9/22; H02K 5/18; H02K 5/20; H02K 9/06; H02K 11/33; H02K 21/16

(52) U.S. Cl. CPC H02K 9/223; H02K 5/18; H02K 5/207; H02K 9/06; H02K 11/33; H02K 21/16; H02K 2205/09

(57) ABSTRACT

An electric drive device includes a rotary electric machine, and a controller integrated with the rotary electric machine and configured to control driving of the rotary electric machine. The rotary electric machine includes a plurality of structural components, and a housing that accommodates the plurality of structural components, the controller includes a plurality of electronic components, and a casing that is adjacent to the housing and accommodates the plurality of electronic components, and a heat insulation component separates the plurality of structural components from the plurality of electronic components, and the heat insulation component includes a partition portion that separates the plurality of electronic components.

### TECHNICAL FIELD

The present invention relates to an electric drive device.

### BACKGROUND ART

In recent years, efforts to realize a low-carbon or carbon-free society have been gaining momentum, and research and development of electrification technologies is being conducted for vehicles, aircrafts, and the like to reduce CO₂ emissions and improve energy efficiency.

For example, WO 2023/057718 A1 discloses an electric drive device (integrated control motor) in which mechanical components are integrated with electrical components. This electric drive device includes a rotary electric machine (electric machine) including a shaft, and a controller (electronic control unit) that controls the rotary electric machine. As shown in FIG. 5 of WO 2023/057718 A1, a heat insulation member is provided between the rotary electric machine and the controller.

By the way, the controller of such an electric drive device includes electronic components (for example, a power module including a semiconductor element and a smoothing capacitor that smooths an electric current input to the power module). These electronic components generate different amounts of heat, and the thermal influence from one electronic component with greater heat generation to another electronic component with smaller heat generation is worried. Accordingly, there is a need for technology that can suppress the thermal influence not only between the structural components of the rotary electric machine and the electronic components of the controller but also between the electronic components of the controller.

### SUMMARY OF THE INVENTION

In view of the above background, an object of the present invention is to suppress not only the thermal influence between the structural components of the rotary electric machine and the electronic components of the controller but also the thermal influence between the electronic components of the controller in the electric drive device in which the controller is integrated with the rotary electric machine. Further, an object thereof is to contribute to the improvement of energy efficiency.

To achieve such an object, one aspect of the present invention provides an electric drive device (16 and 231) comprising: a rotary electric machine (31); and a controller (32 and 233) integrated with the rotary electric machine and configured to control driving of the rotary electric machine, wherein the rotary electric machine includes: a plurality of structural components (39 and 40); and a housing (36) that accommodates the plurality of structural components, the controller includes: a plurality of electronic components (77, 79, 238, and 240); and a casing (74 and 235) that is adjacent to the housing and accommodates the plurality of electronic components, and a heat insulation component (89, 90, and 245) separates the plurality of structural components from the plurality of electronic components, and the heat insulation component includes a partition portion (90 and 263) that separates the plurality of electronic components.

According to this aspect, the heat insulation component separates the structural components of the rotary electric machine from the electronic components of the controller, so that the thermal influence between the structural components of the rotary electric machine and the electronic components of the controller can be suppressed. Further, the partition portion of the heat insulation component separates the electronic components of the controller, so that the thermal influence between the electronic components of the controller can also be suppressed.

In the above aspect, preferably, the plurality of electronic components includes: a power module (77 and 238) including a semiconductor element; and a smoothing capacitor (79 and 240) configured to smooth an electric current input to the power module, and the heat insulation component separates the power module from the smoothing capacitor.

When the heat generation of the power module is compared with the heat generation of the smoothing capacitor, the heat generation of the power module is greater. Further, the smoothing capacitor is a material that is relatively vulnerable to heat. According to the above aspect, the thermal influence from the power module with greater heat generation to the smoothing capacitor with smaller heat generation is suppressed, so that the smoothing capacitor can be protected from heat damage.

In the above aspect, preferably, the power module contacts with an inner circumferential surface of the casing.

According to this aspect, the power module contacts with the inner circumferential surface of the casing with great heat radiation, so that the heat radiation of the power module with great heat generation can be improved.

In the above aspect, preferably, the partition portion (263) includes: a first circumferential plate (271) extending in a circumferential direction; a pair of first radial plates (272) extending from both ends of the first circumferential plate in the circumferential direction toward an outside in a radial direction; a second circumferential plate (273) extending in the circumferential direction on an outside of the first circumferential plate in the radial direction; and a pair of second radial plates (274) extending from both ends of the second circumferential plate in the circumferential direction toward the outside in the radial direction, the first circumferential plate, one of the first radial plates, one of the second radial plates, and the casing define a first storage space (S1) that accommodates the power module, and the first circumferential plate, another of the first radial plates, another of the second radial plates, and the casing define a second storage space (S2) that accommodates the smoothing capacitor.

According to this aspect, the power module and the smoothing capacitor are accommodated in separate housing spaces, so that the heat insulation property between the power module and the smoothing capacitor can be improved.

In the above aspect, preferably, the casing (235) includes: a cylindrical circumferential wall (247) extending in a prescribed axial direction; and a bottom wall (248) closing an opening of the circumferential wall on a side opposite to the rotary electric machine, the bottom wall is provided with a ventilation hole (253) that penetrates therethrough in the axial direction, and the heat insulation component is provided with a notch (260) that overlaps with the ventilation hole as viewed in the axial direction.

According to this aspect, it is possible to connect the internal space of the casing and the external space of the electric drive device through the ventilation hole without closing the ventilation hole by the heat insulation component. Accordingly, the high-temperature air present in the internal space of the casing can be discharged to the external space of the electric drive device through the ventilation hole, so that the cooling performance for the controller can be improved.

In the above aspect, preferably, the plurality of structural components includes: a hollow rotor (39); and a stator (40) arranged on an outer circumference of the rotor, and the ventilation hole is connected to an internal space (IS) of the rotor via the notch.

According to this aspect, not only the high-temperature air present in the internal space of the casing but also the high-temperature air present in the internal space of the housing can be discharged to the external space of the electric drive device through the ventilation hole. Accordingly, not only the cooling performance for the controller but also the cooling performance for the rotary electric machine can be improved.

In the above aspect, preferably, the controller (233) includes an output terminal (255) connected to a terminal (70) of the rotary electric machine in an internal space of the casing, and the heat insulation component is provided with a terminal opening (276) that exposes the output terminal to the rotary electric machine.

According to this aspect, by covering the electronic components of the controller except for the output terminal with the heat insulation component, it is possible to ensure the electrical connection between the rotary electric machine and the controller while suppressing the thermal influence between the structural components of the rotary electric machine and the electronic components of the controller.

In the above aspect, preferably, the heat insulation component includes: a resin layer (257) formed of a resin material; and a metal layer (258) formed of a metal material and provided on the resin layer, and the resin layer is arranged to face one of the rotary electric machine and the controller with greater heat generation.

According to this aspect, the resin layer having lower thermal conductivity than the metal layer is arranged to face the one with greater heat generation. Accordingly, the thermal influence from the one with greater heat generation to the other with smaller heat generation can be suppressed, so that the other with smaller heat generation can be protected from heat damage. Further, the metal layer is provided on the resin layer, so that not only the heat insulation effect but also the shield effect against electromagnetic noise can be enhanced.

In the above aspect, preferably, the rotary electric machine further includes a shaft (38) extending in a prescribed axial direction, the heat insulation component (245) further includes a base portion (262) provided along a plane perpendicular to the axial direction, and the partition portion extends along the axial direction from the base portion toward a side opposite to the rotary electric machine.

According to this aspect, the base portion separates the structural components of the rotary electric machine from the electronic components of the controller in the axial direction, and the partition portion separates the electronic components of the controller in the direction perpendicular to the axial direction. Accordingly, the heat insulation component composed of a single part can suppress the thermal influence between the structural components of the rotary electric machine and the electronic components of the controller and the thermal influence between the electronic components of the controller. Accordingly, compared to a case where the heat insulation component is composed of a plurality of parts, the configuration of the electric drive device can be simplified.

Thus, according to the above aspects, it is possible to suppress not only the thermal influence between the structural components of the rotary electric machine and the electronic components of the controller but also the thermal influence between the electronic components of the controller in the electric drive device in which the controller is integrated with the rotary electric machine.

### BRIEF DESCRIPTION OF THE DRAWING(S)

FIG. 1 is a perspective view of an aircraft according to the first embodiment;

FIG. 2 is a partial cross-sectional view showing a propulsion unit according to the first embodiment;

FIG. 3 is a perspective view showing a propulsion drive device according to the first embodiment;

FIG. 4 is an exploded perspective view showing the propulsion drive device according to the first embodiment;

FIG. 5 is a cross-sectional view showing the propulsion drive device according to the first embodiment;

FIG. 6 is a front view showing a controller according to the first embodiment;

FIG. 7 is a front view showing a smoothing capacitor and its circumference according to the first embodiment;

FIG. 8 is a perspective view showing fixing structures of power modules according to the first embodiment;

FIG. 9 is a circuit diagram showing a DC power supply and the propulsion drive device according to the first embodiment;

FIG. 10 is a perspective cross-sectional view showing the smoothing capacitor and its circumference according to the first embodiment;

FIG. 11 is a perspective view showing the smoothing capacitor according to the first embodiment;

FIG. 12 is a perspective view showing a case opening and its circumference according to the first embodiment;

FIG. 13 is a perspective view showing an electric connection structure of the controller according to the first embodiment;

FIG. 14 is a cross-sectional view showing a propulsion drive device according to the second embodiment;

FIG. 15 is a front view showing a controller according to the second embodiment;

FIG. 16 is a front view showing the controller without a heat insulation component according to the second embodiment; and

FIG. 17 is a perspective view showing the heat insulation component according to the second embodiment.

### DETAILED DESCRIPTION OF THE INVENTION

### The First Embodiment

### <The Aircraft 1>

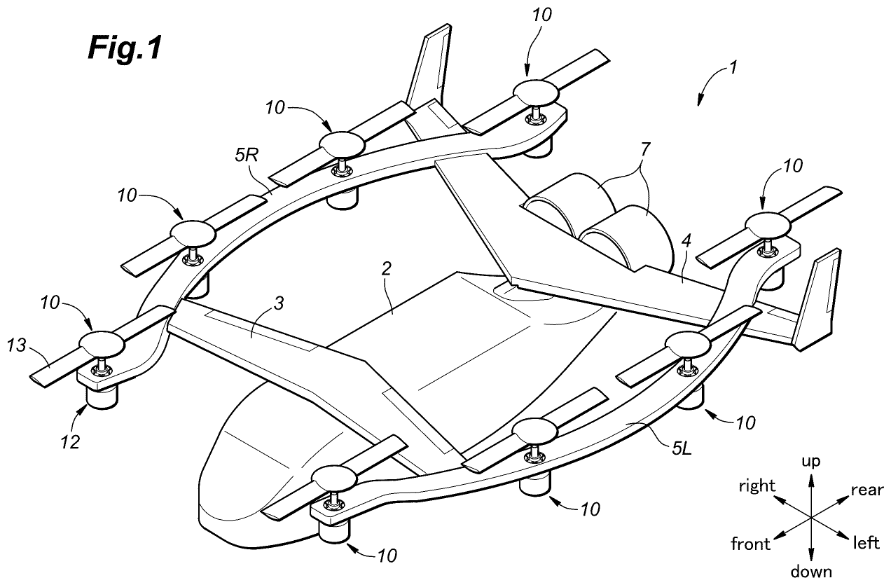

In the following, an aircraft 1 (an example of a mobile body) according to the first embodiment of the present invention will be described with reference to FIGS. 1 to 13.

With reference to FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4.

A cabin (not shown) for an occupant to board is provided in the front portion of the body 2. Left and right propulsion units 7 (which will be described later) for applying the forward propulsion force to the aircraft 1 are provided at the rear end of the body 2. The propulsion units 7 may also be called “cruise units”.

The left arm 5L and the right arm 5R are each provided with a plurality of (for example, four) lift units 10 for applying the ascending and descending forces to the aircraft 1. The plurality of lift units 10 is arranged at intervals in the front-and-rear direction. The lift units 10 may also be called “vertical take-off and landing (VTOL) units”. Each lift unit 10 includes a lift drive device 12 and a lift rotor 13 attached to the lift drive device 12. The lift drive device 12 includes an electric motor (not shown), and is configured to rotate the lift rotor 13 by the driving force of the electric motor.

### <The Propulsion Unit 7>

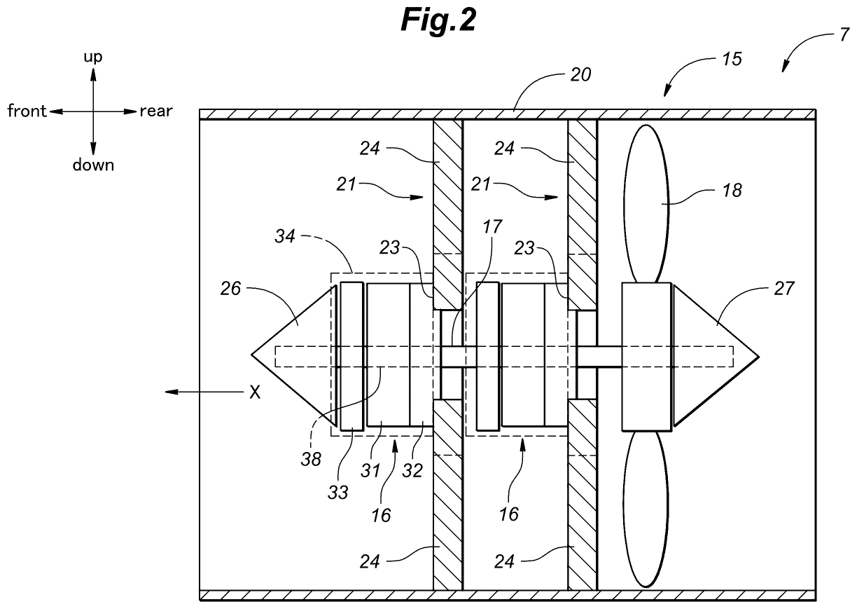

With reference to FIG. 2, each propulsion unit 7 includes a support body 15, front and rear propulsion drive devices 16 (an example of electric drive devices) supported by the support body 15, a rotation shaft 17 extending in the front-and-rear direction and rotatably supported by the front and rear propulsion drive devices 16, and a propulsion rotor 18 fixed to the rear portion of the rotation shaft 17.

The support body 15 is fixed to the rear end of the body 2 (see FIG. 1). The support body 15 includes a cylindrical nacelle 20 extending in the front-and-rear direction, and front and rear mount frames 21 fixed to the inner circumferential surface of the nacelle 20. Each mount frame 21 includes an annular hub 23 that is concentric with the nacelle 20, and a plurality of spokes 24 extending radially from the outer circumferential surface of the hub 23 and connected to the inner circumferential surface of the nacelle 20.

The front and rear propulsion drive devices 16 are accommodated in the nacelle 20. The front and rear propulsion drive devices 16 are fixed to the front surface of the hub 23 of the front and rear mount frames 21, respectively. The details of each propulsion drive device 16 will be described later.

The rotation shaft 17 is accommodated in the nacelle 20. The rotation shaft 17 penetrates through the hub 23 of each mount frame 21. A conical front cover 26 the diameter of which increases toward the rear is fixed to the front end of the rotation shaft 17. The front cover 26 is arranged in front of the front propulsion drive device 16. A conical rear cover 27 the diameter of which increases toward the front is fixed to the rear end of the rotation shaft 17. The rear cover 27 is arranged behind the central portion of the propulsion rotor 18.

The propulsion rotor 18 is accommodated in the nacelle 20. The propulsion rotor 18 is configured to rotate integrally with the rotation shaft 17 according to the rotation of the rotation shaft 17, thereby applying the forward propulsion force to the aircraft 1.

### <The Propulsion Drive Device 16>

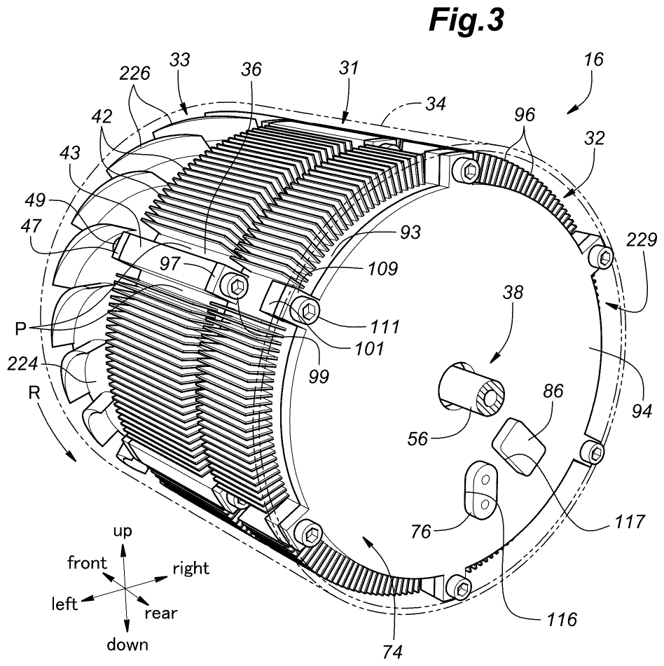

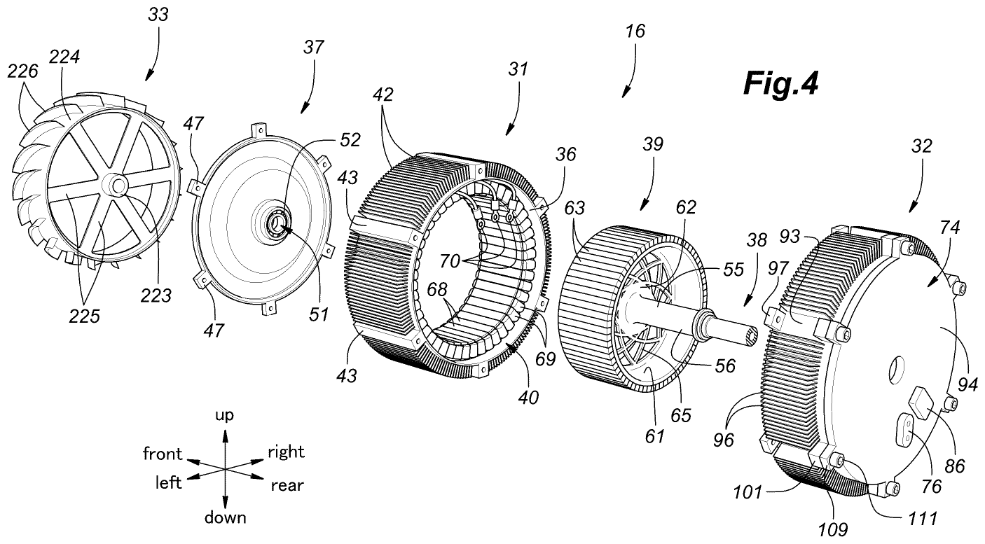

With reference to FIGS. 2 and 3, each propulsion drive device 16 includes an electric motor 31 (an example of a rotary electric machine), a controller 32 arranged on the rear side of the electric motor 31, a fan 33 arranged on the front side of the electric motor 31, and a duct cover 34 that covers the outer circumference of the electric motor 31, the controller 32, and the fan 33. In FIG. 4, the duct cover 34 is omitted.

### <The Electric Motor 31>

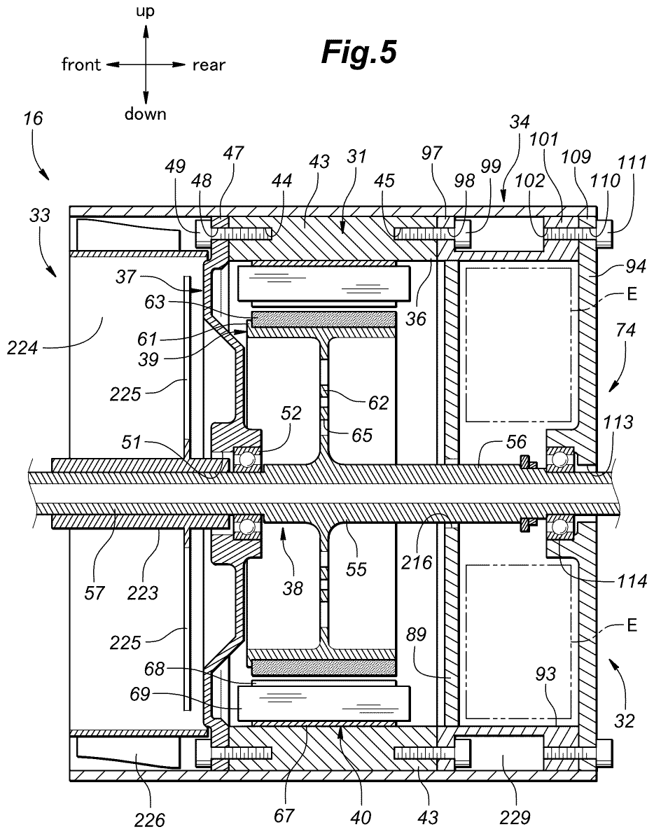

With reference to FIGS. 4 and 5, the electric motor 31 is sandwiched between the controller 32 and the fan 33. For example, the electric motor 31 is a three-phase AC motor of an inner rotor type. The electric motor 31 includes a housing 36, a lid 37, a shaft 38, a rotor 39, and a stator 40.

The housing 36 is cylindrical and extends in the front-and-rear direction on the outer circumference of the shaft 38. The housing 36 is arranged on the outer circumference of the rotor 39 and the stator 40 and accommodates the rotor 39 and the stator 40 (an example of structural components of the electric motor 31).

A plurality of first cooling fins 42 protrudes from the outer circumferential surface of the housing 36 at intervals in the circumferential direction of the housing 36. The plurality of first cooling fins 42 is formed integrally with the housing 36. Each first cooling fin 42 has a flat plate shape and extends along the front-and-rear direction. Each first cooling fin 42 extends continuously from the front end (one end in the front-and-rear direction) of the housing 36 to the rear end (the other end in the front-and-rear direction) thereof.

A plurality of fastening protrusions 43 protrudes from the outer circumferential surface of the housing 36 at intervals in the circumferential direction of the housing 36. The plurality of fastening protrusions 43 is provided between adjacent first cooling fins 42. Passages P of the cooling air that extend continuously from the front end of the housing 36 to the rear end thereof are formed between the adjacent first cooling fins 42 and each fastening protrusion 43. The plurality of fastening protrusions 43 is formed integrally with the housing 36.

Each fastening protrusion 43 is a rod-shaped portion with a rectangular cross-section and extends along the front-and-rear direction. That is, each fastening protrusion 43 extends parallel to each first cooling fin 42. Each fastening protrusion 43 extends continuously from the front end (one end in the front-and-rear direction) of the housing 36 to the rear end (the other end in the front-and-rear direction) thereof. Each fastening protrusion 43 is integrally formed of the same material from the front end (one end in the front-and-rear direction) of each fastening protrusion 43 to the rear end (the other end in the front-and-rear direction) thereof.

The front end of each fastening protrusion 43 is provided with a first bolt hole 44 for fastening the lid 37 to the housing 36. The rear end of each fastening protrusion 43 is provided with a second bolt hole 45 for fastening a casing 74 of the controller 32 (which will be described later) to the housing 36. The first bolt hole 44 and the second bolt hole 45 extend along the front-and-rear direction.

The lid 37 is adjacent to the housing 36 and closes the opening of the housing 36 on the front side (the side opposite to the controller 32). The lid 37 is a disk-shaped member and extends along a plane perpendicular to the front-and-rear direction. The lid 37 is formed separately from the housing 36. In another embodiment, the lid 37 may be formed integrally with the housing 36.

A plurality of first fastening pieces 47 protrudes from the outer circumferential portion of the lid 37 at intervals in the circumferential direction of the lid 37. Each first fastening piece 47 is provided with a first fastening hole 48 formed in the front-and-rear direction. The lid 37 is fastened to the housing 36 as a first fastening bolt 49 penetrating through the first fastening hole 48 engages with the first bolt hole 44 of each fastening protrusion 43 of the housing 36. A circular first through hole 51 is provided in the front-and-rear direction in the central portion of the lid 37. A first bearing 52 is attached to the first through hole 51.

With reference to FIG. 2, the shaft 38 extends in the front-and-rear direction (an example of the prescribed axial direction). The shaft 38 constitutes a portion of the rotation shaft 17 of the propulsion unit 7. Accordingly, as the shaft 38 rotates, the entire rotation shaft 17 rotates, and the propulsion rotor 18 rotates integrally with the rotation shaft 17. This applies the forward propulsion force to the aircraft 1, thereby propelling the aircraft 1 forward. The shaft 38 extends along the propulsion direction of the aircraft 1 (see an arrow X in FIG. 2).

With reference to FIG. 5, the shaft 38 is hollow. The shaft 38 includes a main body 55 accommodated in the housing 36, an extending portion 56 extending from the main body 55 toward the rear side (toward the controller 32), and a protruding portion 57 protruding from the main body 55 toward the front side (the side opposite to the controller 32). The protruding portion 57 penetrates through the first through hole 51 of the lid 37 and extends to the space on the front side of the electric motor 31. The protruding portion 57 is rotatably supported by the lid 37 via the first bearing 52.

With reference to FIGS. 4 and 5, the rotor 39 is hollow. The rotor 39 is arranged on the outer circumference of the main body 55 of the shaft 38. The rotor 39 includes a cylindrical rotor core 61 extending in the front-and-rear direction, a rotor plate 62 extending in the radial direction and connecting the main body 55 of the shaft 38 and the rotor core 61, and a plurality of permanent magnets 63 fixed to the outer circumferential surface of the rotor core 61. The rotor core 61 and the rotor plate 62 are formed integrally with the shaft 38. The rotor plate 62 is provided with a plurality of communication holes 65 penetrating therethrough in the front-and-rear direction.

The stator 40 is arranged on the outer circumference of the rotor 39 and faces the rotor 39 at a distance. The stator 40 includes a cylindrical stator core 67 extending in the front-and-rear direction, a plurality of teeth 68 protruding from the inner circumferential surface of the stator core 67, a plurality of coils 69 wound around the plurality of teeth 68, and three motor terminals 70 (an example of terminals of the rotary electric machine) connected to the plurality of coils 69. The stator core 67 is fixed to the inner circumferential surface of the housing 36. Among the components of the electric motor 31 and the controller 32, the plurality of coils 69 has the greatest heat generation. Accordingly, the heat generation of the electric motor 31 is greater than the heat generation of the controller 32. The three motor terminals 70 correspond to the U-phase, V-phase, and W-phase of the three-phase AC, respectively.

### <The Controller 32>

With reference to FIGS. 3 and 4, the controller 32 is integrated with the electric motor 31 and configured to control driving of the electric motor 31. In other words, the propulsion drive device 16 according to the present embodiment is a drive device in which the controller 32 is integrated with the electric motor 31.

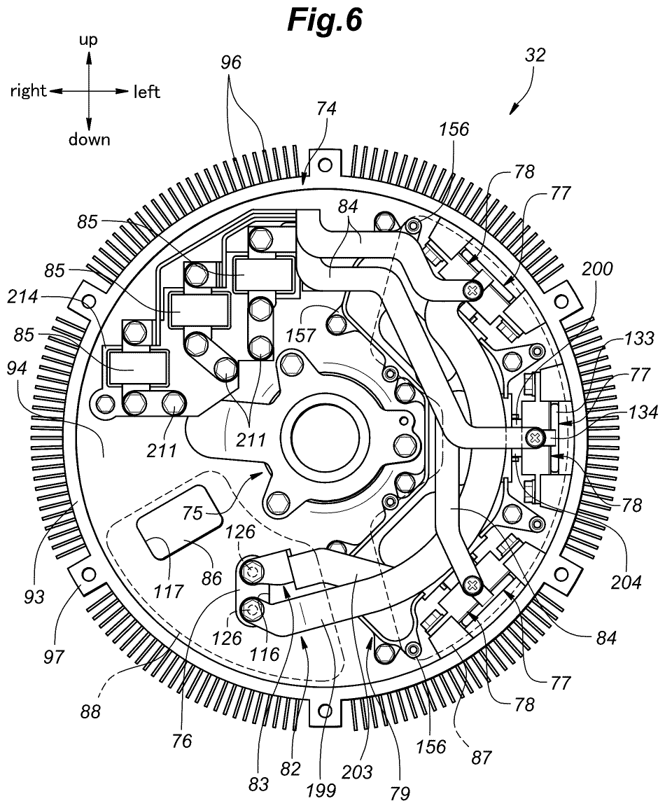

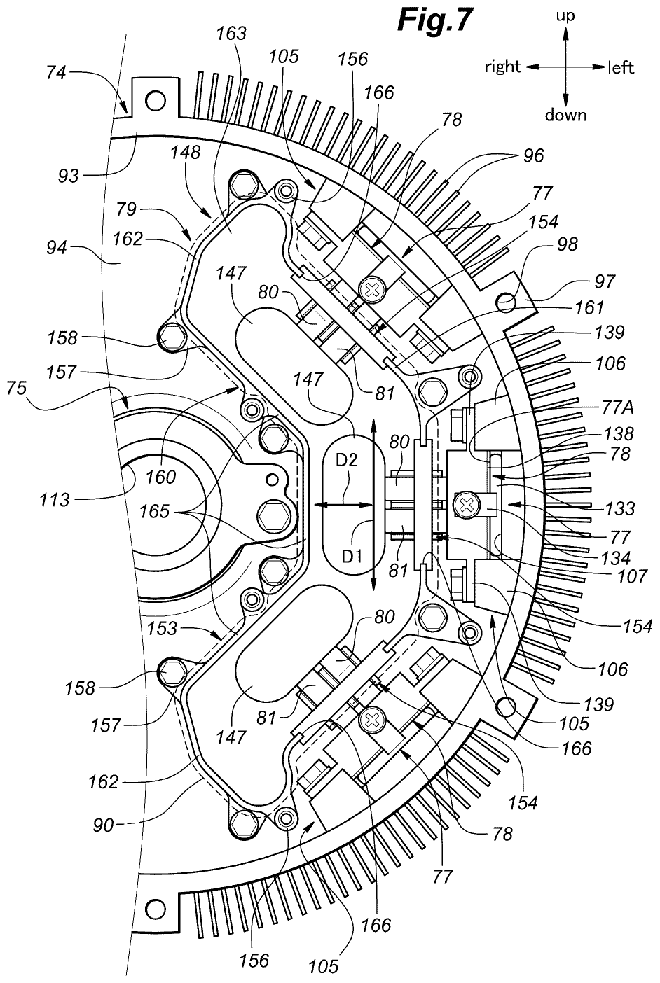

With reference to FIGS. 6 and 7, the controller 32 includes a casing 74, a resolver 75, a DC input connector 76, three power modules 77, three pressing members 78, a smoothing capacitor 79, three first connection members 80, three second connection members 81, first and second DC bus bars 82, 83, three AC bus bars 84, three electric current sensors 85, a communication connector 86, a drive board 87, a control board 88, and heat insulation components 89, 90 (see FIGS. 5 and 7). Further, in FIG. 5, electronic components E (for example, the three power modules 77, the smoothing capacitor 79, the three electric current sensors 85, the drive board 87, and the control board 88) of the controller 32 are omitted, and only the outline of the electronic components E is shown.

With reference to FIG. 5, the casing 74 is adjacent to the housing 36 of the electric motor 31. The casing 74 is made of metal and has a cylindrical shape with a bottom. The casing 74 accommodates the electronic components E of the controller 32.

The casing 74 includes a cylindrical circumferential wall 93 extending in the front-and-rear direction on the outer circumference of the extending portion 56 of the shaft 38, and a bottom wall 94 closing the opening of the circumferential wall 93 on the rear side (the side opposite to the electric motor 31). Hereinafter, the term “circumferential direction” used in the description of the components of the controller 32 will refer to the circumferential direction of the circumferential wall 93 of the casing 74 (in other words, the circumferential direction centered on the extending portion 56 of the shaft 38), and the term “radial direction” used in the description of the components of the controller 32 will refer to the radial direction of the circumferential wall 93 of the casing 74 (in other words, the radial direction centered on the extending portion 56 of the shaft 38).

With reference to FIGS. 3 and 4, a plurality of second cooling fins 96 protrudes from the outer circumferential surface of the circumferential wall 93 of the casing 74 at intervals in the circumferential direction. The plurality of second cooling fins 96 is formed integrally with the circumferential wall 93. Each second cooling fin 96 has a flat plate shape and extends along the front-and-rear direction. Each second cooling fin 96 extends continuously from the front end (one end in the front-and-rear direction) of the circumferential wall 93 to the rear end (the other end in the front-and-rear direction) thereof.

With reference to FIGS. 3 and 5, a plurality of second fastening pieces 97 protrudes at intervals in the circumferential direction from the front end (the end on the side of the electric motor 31) of the outer circumferential surface of the circumferential wall 93 of the casing 74. Each second fastening piece 97 is provided with a second fastening hole 98 formed in the front-and-rear direction. The casing 74 is fastened to the housing 36 as a second fastening bolt 99 penetrating through the second fastening hole 98 engages with the second bolt hole 45 of each fastening protrusion 43 of the housing 36.

A plurality of third fastening pieces 101 protrudes at intervals in the circumferential direction from the rear end (the end opposite to the electric motor 31) of the outer circumferential surface of the circumferential wall 93 of the casing 74. Each third fastening piece 101 is provided with a third fastening hole 102 formed in the front-and-rear direction.

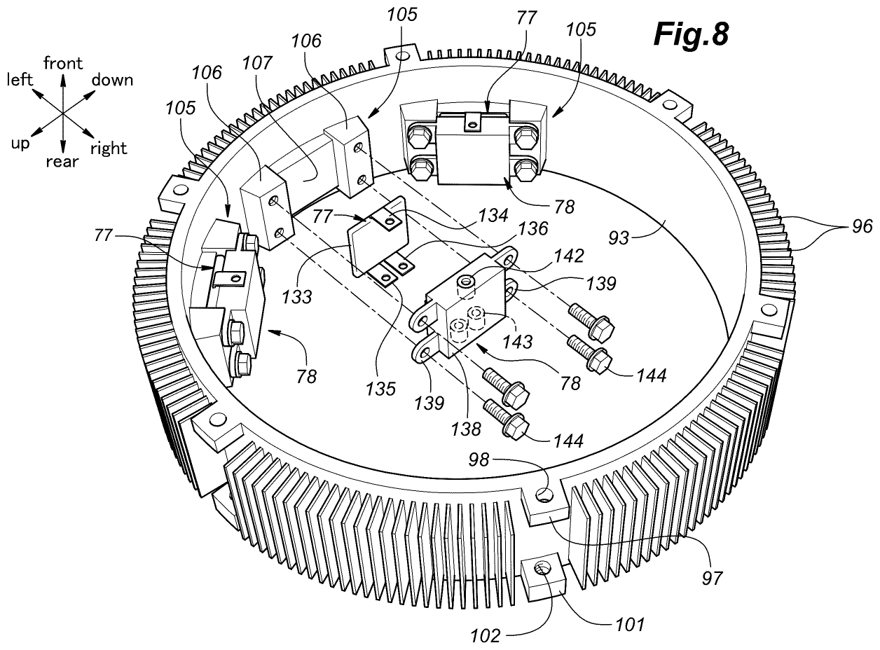

With reference to FIGS. 7 and 8, three pedestals 105 protrude from the inner circumferential surface of the circumferential wall 93 of the casing 74 at intervals in the circumferential direction. A pair of fixing protrusions 106 protrudes from both side portions in the circumferential direction of the inner surface (the inside surface in the radial direction) of each pedestal 105. An engagement recess 107 is provided between the pair of fixing protrusions 106 and in the central portion in the circumferential direction of the inner surface of each pedestal 105. Two of the three pedestals 105 are arranged such that the position of one of the fixing protrusions 106 in the circumferential direction overlaps with the position of one of the second fastening pieces 97 in the circumferential direction, and the other of the fixing protrusions 106 is arranged between the second fastening pieces 97 such that the position of the other of the fixing protrusions 106 in the circumferential direction does not overlap with the positions of the second fastening pieces 97 in the circumferential direction.

With reference to FIGS. 5 and 6, the bottom wall 94 of the casing 74 is a disk-shaped portion and extends along a plane perpendicular to the front-and-rear direction. The bottom wall 94 is formed separately from the circumferential wall 93. In another embodiment, the bottom wall 94 may be formed integrally with the circumferential wall 93.

A plurality of fourth fastening pieces 109 protrudes from the outer circumferential portion of the bottom wall 94 of the casing 74 at intervals in the circumferential direction. Each fourth fastening piece 109 is provided with a fourth fastening hole 110 formed in the front-and-rear direction. The bottom wall 94 is fastened to the circumferential wall 93 as a third fastening bolt 111 penetrating through the fourth fastening hole 110 engages with the third fastening hole 102 of each third fastening piece 101 of the circumferential wall 93.

A circular second through hole 113 is provided in the front-and-rear direction in the central portion of the bottom wall 94 of the casing 74. A second bearing 114 is attached to the second through hole 113. The extending portion 56 of the shaft 38 penetrates through the second through hole 113. The extending portion 56 of the shaft 38 is rotatably supported by the second through hole 113 via the second bearing 114. The lower portion of the bottom wall 94 is provided with a first fitting hole 116 and a second fitting hole 117 formed in the front-and-rear direction. The first fitting hole 116 and the second fitting hole 117 are provided at a distance from each other in the circumferential direction.

With reference to FIG. 6, the resolver 75 is fixed to the central portion of the bottom wall 94 of the casing 74. The resolver 75 includes a plurality of detection units (not shown) for detecting the rotation of the extending portion 56 of the shaft 38. The plurality of detection units are arranged at intervals in the circumferential direction.

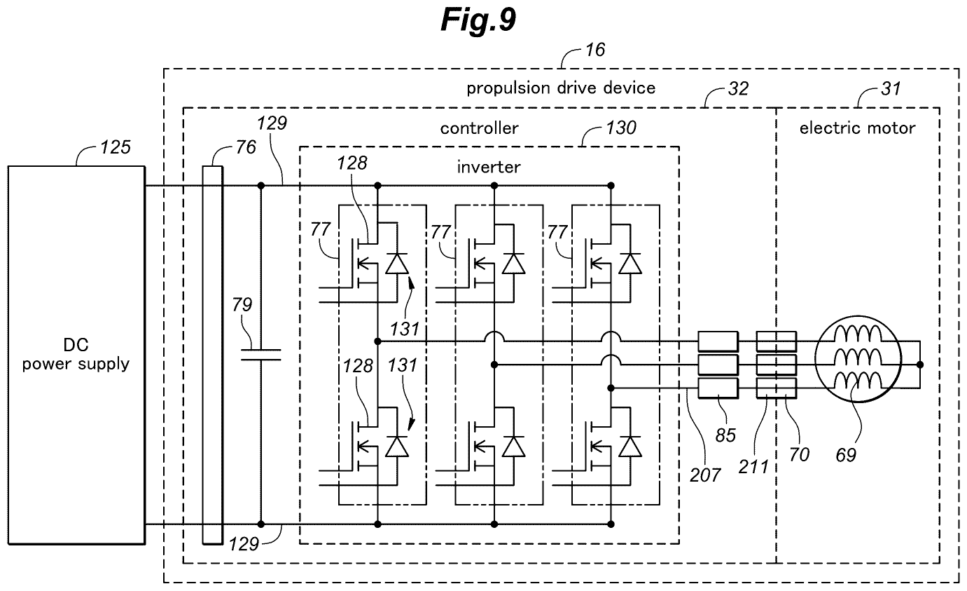

With reference to FIG. 9, the DC input connector 76 is connected to a DC power supply 125 provided outside the propulsion drive device 16. For example, the DC power supply 125 may be composed of a battery or a generator.

With reference to FIGS. 3 and 6, the DC input connector 76 fits into the first fitting hole 116 of the bottom wall 94 of the casing 74 and penetrates through the bottom wall 94 of the casing 74. A pair of DC input terminals 126 is provided on the front surface (the surface on the side of the electric motor 31) of the DC input connector 76.

With reference to FIG. 9, the three power modules 77 each include two switching elements 128. That is, the controller 32 includes a total of six switching elements 128. The six switching elements 128 are components of an inverter 130 (an example of a power conversion circuit) that converts DC power (direct current) input from the DC power supply 125 via a pair of DC lines 129 into AC power (alternating current). Each switching element 128 is composed of a semiconductor element such as an IGBT or a MOSFET. Each switching element 128 is arranged in parallel with a freewheel diode 131.

With reference to FIGS. 7 and 8, the three power modules 77 are arranged at intervals in the circumferential direction and contact with the inner circumferential surface of the circumferential wall 93 of the casing 74. The positions of the three power modules 77 in the circumferential direction do not overlap with the positions of the plurality of second fastening pieces 97 (i.e., the fastening points of the casing 74 and the housing 36) in the circumferential direction, but overlap with the positions of the plurality of second cooling fins 96 in the circumferential direction. The three power modules 77 are arranged to avoid the uppermost portion of the casing 74. An arrow D1 appropriately shown in each drawing indicates a direction (hereinafter referred to as “the first direction D1”) parallel to an inner surface 77A of each power module 77. An arrow D2 appropriately shown in each drawing indicates a direction (hereinafter referred to as “the second direction D2”) perpendicular to the first direction D1 and the inner surface 77A of each power module 77.

Each power module 77 includes a flat module body 133, an AC module bus bar 134 extending from the front end (one end in the front-and-rear direction) of the module body 133 toward the inside in the radial direction, and a first DC module bus bar 135 and a second DC module bus bar 136 extending from the rear end (the other end in the front-and-rear direction) of the module body 133 toward the inside in the radial direction.

The three pressing members 78 are arranged at intervals in the circumferential direction. Each pressing member 78 includes a rectangular parallelepiped engagement piece 138 and a plurality of protruding pieces 139 protruding from the engagement piece 138 toward both sides in the circumferential direction. The engagement piece 138 engages with the engagement recess 107 of each pedestal 105 arranged on the inner circumferential surface of the circumferential wall 93 of the casing 74. The engagement piece 138 and the engagement recess 107 of each pedestal 105 sandwich the module body 133 of each power module 77. The engagement piece 138 presses the module body 133 of each power module 77 against the engagement recess 107 of each pedestal 105. An AC insert nut 142 is embedded in the front surface (the surface on one side in the front-and-rear direction) of the engagement piece 138. Two DC insert nuts 143 are embedded in the rear surface (the surface on the other side in the front-and-rear direction) of the engagement piece 138. Each protruding piece 139 is fixed to each fixing protrusion 106 of each pedestal 105 by a fixing bolt 144.

With reference to FIG. 9, the smoothing capacitor 79 is connected to the DC power supply 125 in parallel with the inverter 130. The smoothing capacitor 79 smooths the direct current input to the inverter 130 from the DC power supply 125. More specifically, the smoothing capacitor 79 protects the three power modules 77 by smoothing a pulse electric current (a pulse-shaped electric current caused by a surge voltage) generated in the direct current input from the DC power supply 125 to the three power modules 77.

With reference to FIG. 7, the smoothing capacitor 79 is arranged at an interval from the inner circumferential surface of the circumferential wall 93 of the casing 74. The smoothing capacitor 79 and the three power modules 77 are arranged in the left semicircular portion (an example of one semicircular portion) of the casing 74. The smoothing capacitor 79 is continuously arranged along the inner surfaces 77A of the three power modules 77 (more specifically, the inner surfaces in the radial direction of the module bodies 133 of the three power modules 77). Accordingly, as viewed from the front side (the side of the electric motor 31), the smoothing capacitor 79 and each power module 77 are arranged in order from the inside in the radial direction to the outside in the radial direction between the second through hole 113 of the bottom wall 94 of the casing 74 and the inner circumferential surface of the circumferential wall 93 of the casing 74.

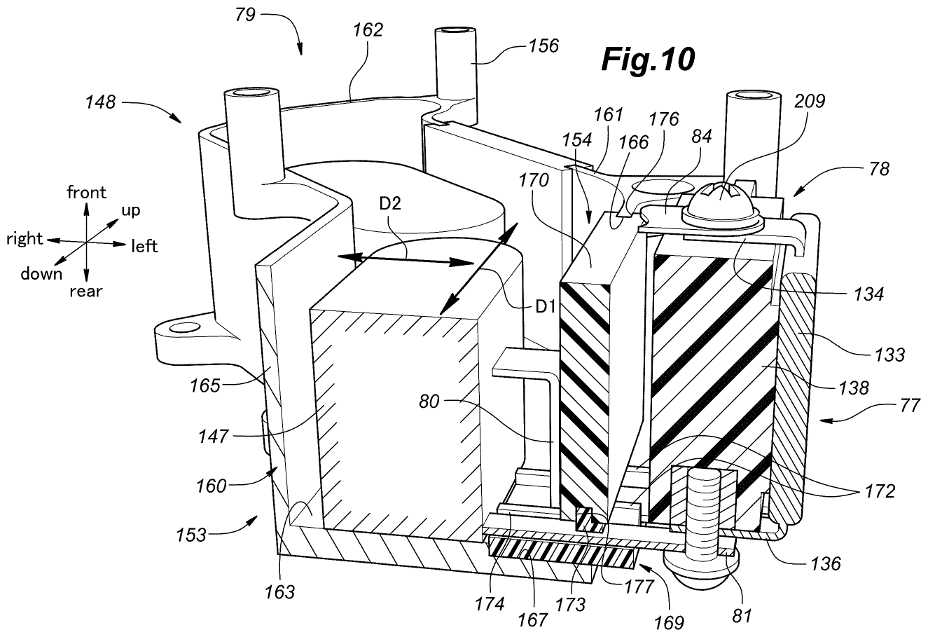

With reference to FIG. 10, the smoothing capacitor 79 is arranged at a distance in the radial direction from each power module 77. The smoothing capacitor 79 and each power module 77 are arranged on the same plane perpendicular to the front-and-rear direction. In other words, the position of the smoothing capacitor 79 in the front-and-rear direction overlaps with the position of each power module 77 in the front-and-rear direction.

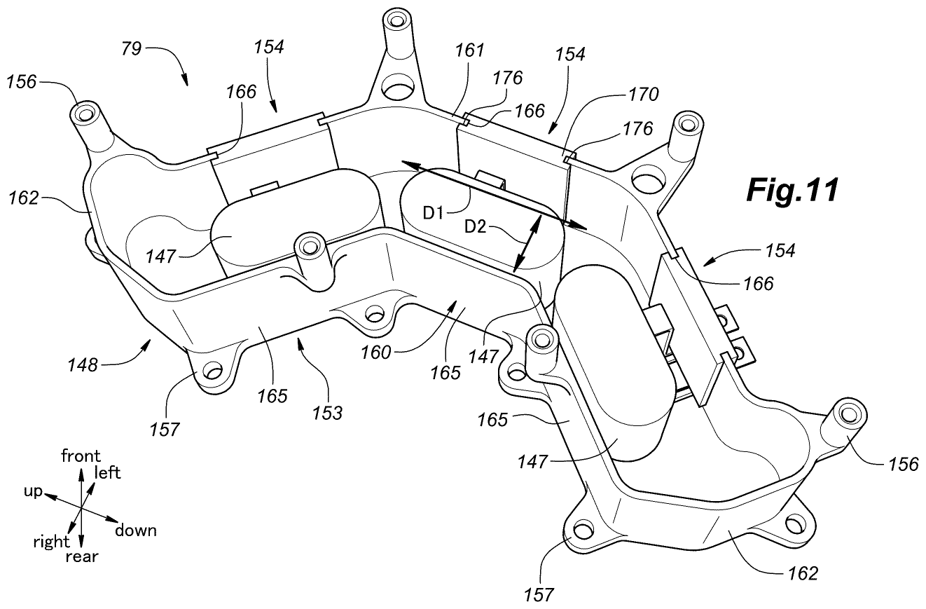

With reference to FIGS. 7 and 11, the smoothing capacitor 79 includes a plurality of capacitor elements 147 and a capacitor case 148 that accommodates the plurality of capacitor elements 147. That is, the smoothing capacitor 79 is configured as a capacitor unit that integrates the plurality of capacitor elements 147. As viewed from the front side (the side of the electric motor 31), the smoothing capacitor 79 is bent to protrude toward each power module 77 (toward the outside in the radial direction), and is a substantially U-shaped member.

The capacitor case 148 is filled with a potting material (not shown). For example, the potting material is made of an insulating resin. The capacitor case 148 includes a case body 153 and three closing members 154 attached to the case body 153.

The case body 153 of the capacitor case 148 is made of a metal such as aluminum. The case body 153 is a box-shaped member with the front surface (the surface on one side in the front-and-rear direction) opened. A plurality of support protrusions 156 is provided at the front end (one end in the front-and-rear direction) of the case body 153. A plurality of attachment protrusions 157 is provided at the rear end (the other end in the front-and-rear direction) of the case body 153. Each attachment protrusion 157 is attached to the bottom wall 94 of the casing 74 by an attachment bolt 158.

The case body 153 of the capacitor case 148 includes an inner wall 160 (a wall on the inside in the radial direction) extending in the circumferential direction, an outer wall 161 (a wall on the outside in the radial direction) extending in the circumferential direction on the outside in the radial direction of the inner wall 160, a pair of sidewalls 162 extending in the radial direction and connecting both ends of the inner wall 160 in the circumferential direction to both ends of the outer wall 161 in the circumferential direction, and a base wall 163 connecting the rear ends (the ends on the side opposite to the electric motor 31) of the inner wall 160, the outer wall 161, and the pair of sidewalls 162. The inner wall 160 has three flat surfaces 165 formed on the inside in the radial direction of the plurality of the capacitor elements 147. As viewed from the front side (the side of the electric motor 31), each flat surface 165 extends along the first direction D1. Three case openings 166 are formed in the outer wall 161 on the outside in the radial direction of the plurality of capacitor elements 147. The three case openings 166 are arranged at intervals in the circumferential direction. Each case opening 166 has a rectangular shape elongated in the front-and-rear direction and the first direction D1. Three fitting recesses 167 (see FIG. 10) are formed in the outside portion in the radial direction of the base wall 163 at positions facing the three case openings 166.

With reference to FIGS. 7 and 10, the three closing members 154 of the capacitor case 148 close the three case openings 166 of the case body 153, respectively. Each closing member 154 is made of an insulating resin. Each closing member 154 includes a first closing piece 169 and a second closing piece 170 that is arranged on the front side (one side in the front-and-rear direction) of the first closing piece 169.

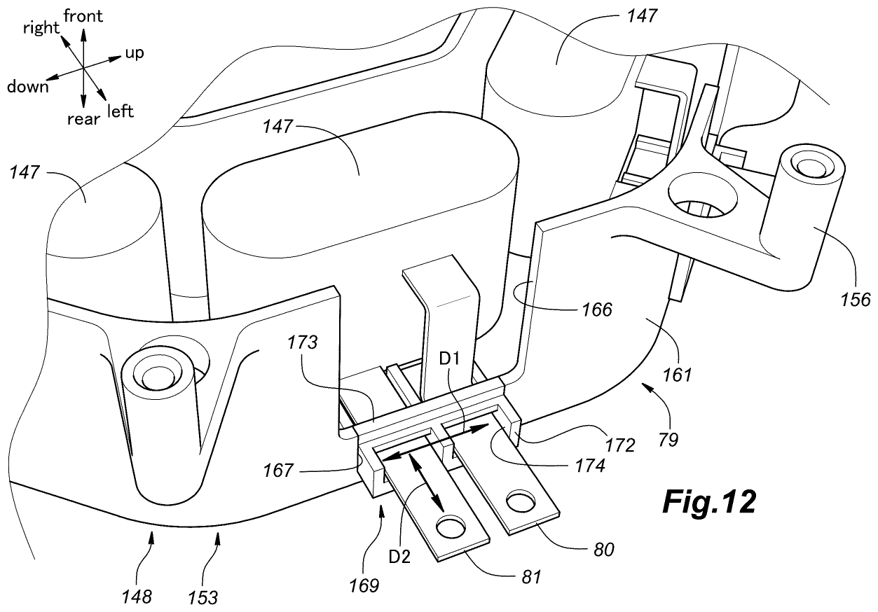

With reference to FIGS. 10 and 12, the first closing piece 169 of each closing member 154 fits into each fitting recess 167 of the case body 153. The front surface (the surface on one side in the front-and-rear direction) of the first closing piece 169 is provided with three partition ribs 172 extending in the second direction D2 and a connection rib 173 extending in the first direction D1 and connecting the middle portions of the three partition ribs 172. Two attachment grooves 174 extending in the second direction D2 are provided between the three partition ribs 172 and on the rear side (the other side in the front-and-rear direction) of the connection rib 173.

With reference to FIGS. 10 and 11, the second closing piece 170 of each closing member 154 is formed separately from the first closing piece 169. The second closing piece 170 has a flat rectangular parallelepiped shape elongated in the front-and-rear direction and the first direction D1. A pair of first engagement grooves 176 extending in the front-and-rear direction is formed in both side portions of the second closing piece 170 in the first direction D1. The pair of first engagement grooves 176 engages with the outer wall 161 of the case body 153 on both sides of each case opening 166 in the first direction D1. The front end (one end in the front-and-rear direction) of the second closing piece 170 is provided flush with the front surface (the surface on one side in the front-and-rear direction) of the outer wall 161 of the case body 153. A second engagement groove 177 extending in the first direction D1 is formed on the rear end (the other end in the front-and-rear direction) of the second closing piece 170. The second engagement groove 177 engages with the connection rib 173 of the first closing piece 169.

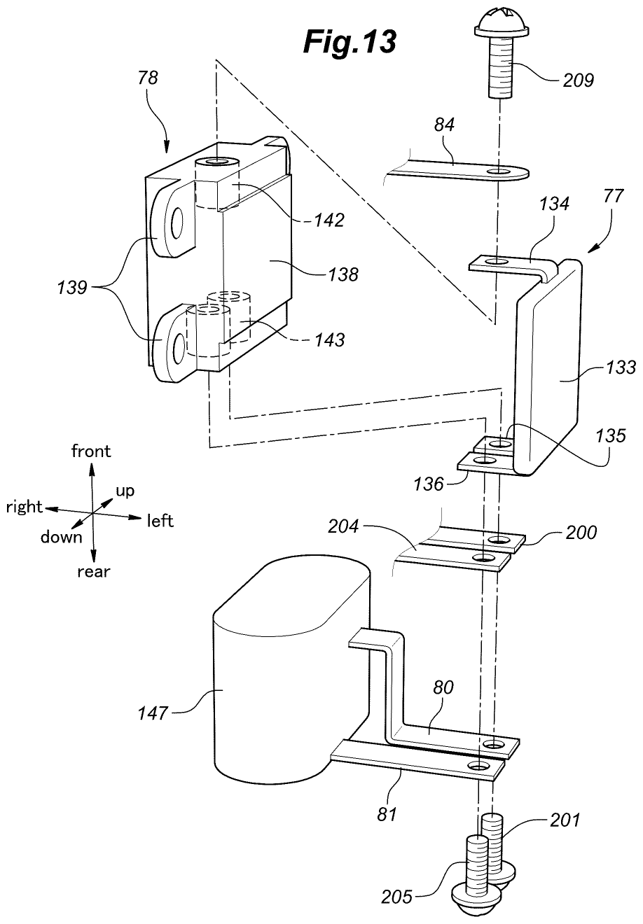

With reference to FIGS. 10 and 13, each first connection member 80 connects each capacitor element 147 to each power module 77. The end on the inside in the radial direction of each first connection member 80 is connected to the upper portion of the side surface (the surface on the outside in the radial direction) of each capacitor element 147. Each first connection member 80 engages with one attachment groove 174 of the first closing piece 169 of each closing member 154. Each first connection member 80 passes through the rear side of the second closing piece 170 (see FIGS. 10 and 11) of each closing member 154 and extends to the rear side of each power module 77. That is, each first connection member 80 penetrates through each closing member 154.

With reference to FIGS. 10 and 13, each second connection member 81 connects each capacitor element 147 to each power module 77. The end on the inside in the radial direction of each second connection member 81 is connected to the lower portion of the side surface (the surface on the outside in the radial direction) of each capacitor element 147. Each second connection member 81 engages with the other attachment groove 174 of the first closing piece 169 of each closing member 154. Each second connection member 81 passes through the rear side of the second closing piece 170 (see FIGS. 10 and 11) of each closing member 154 and extends to the rear side of each power module 77. That is, each second connection member 81 penetrates through each closing member 154.

With reference to FIG. 6, the first DC bus bar 82 includes a first main bus bar 199 extending in the circumferential direction, and three first auxiliary bus bars 200 bent from the outer circumferential portion of the first main bus bar 199 toward the rear side. One end of the first main bus bar 199 in the circumferential direction is connected to one DC input terminal 126 of the DC input connector 76. With reference to FIG. 13, the tip end of each first auxiliary bus bar 200 is bent toward the outside in the radial direction and extends to the rear side of each pressing member 78. The tip end of each first auxiliary bus bar 200, the first DC module bus bar 135 of each power module 77, and the end on the outside in the radial direction of each first connection member 80 are fixed to one DC insert nut 143 of each pressing member 78 by a first fixing bolt 201. Accordingly, the first DC bus bar 82, each power module 77, and each first connection member 80 are connected to each other.

With reference to FIG. 6, the second DC bus bar 83 includes a second main bus bar 203 extending in the circumferential direction, and three second auxiliary bus bars 204 bent from the outer circumferential portion of the second main bus bar 203 toward the rear side. One end of the second main bus bar 203 in the circumferential direction is connected to the other DC input terminal 126 of the DC input connector 76. With reference to FIG. 13, the tip end of each second auxiliary bus bar 204 is bent toward the outside in the radial direction and extends to the rear side of each pressing member 78. The tip end of each second auxiliary bus bar 204, the second DC module bus bar 136 of each power module 77, and the end on the outside in the radial direction of each second connection member 81 are fixed to the other DC insert nut 143 of each pressing member 78 by a second fixing bolt 205. Accordingly, the second DC bus bar 83, each power module 77, and each second connection member 81 are connected to each other.

With reference to FIGS. 6 and 13, one end in the longitudinal direction of each AC bus bar 84 and the AC module bus bar 134 of each power module 77 are fixed to the AC insert nut 142 of each pressing member 78 by a third fixing bolt 209. Accordingly, each AC bus bar 84 and each power module 77 are connected to each other. An AC output terminal 211 is provided at the other end in the longitudinal direction of each AC bus bar 84. That is, the controller 32 is provided with three AC output terminals 211. The three AC output terminals 211 and the pair of DC input terminals 126 are arranged in the right semicircular portion (an example of the other semicircular portion) of the casing 74. The three AC output terminals 211 are arranged at an interval in the circumferential direction from the pair of DC input terminals 126. The AC output terminals 211 are connected to the motor terminals 70 (see FIG. 4) of the stator 40 of the electric motor 31 in the internal space of the casing 74. Accordingly, as shown in FIG. 9, the alternating current output from the inverter 130 (three power modules 77) is output to each coil 69 of the electric motor 31 via each AC output terminal 211 and each motor terminal 70.

With reference to FIG. 9, the three electric current sensors 85 are arranged on three AC lines 207 (three-phase lines), respectively. The three AC lines 207 extend from the inverter 130 (three power modules 77) to each coil 69 of the electric motor 31. The three electric current sensors 85 detect the values of the electric currents output from the three power modules 77.

With reference to FIG. 6, the three electric current sensors 85 are arranged on the three AC bus bars 84, respectively. The three electric current sensors 85 are arranged in the right semicircular portion of the casing 74. The three electric current sensors 85 are arranged at intervals in the circumferential direction. The three electric current sensors 85 are fixed to a sensor holder 214 fixed to the outer circumferential portion of the bottom wall 94 of the casing 74. The sensor holder 214 is formed separately from the resolver 75.

The communication connector 86 is arranged between the pair of DC input terminals 126 and the three AC output terminals 211 in the circumferential direction. The communication connector 86 fits into the second fitting hole 117 of the bottom wall 94 of the casing 74 and penetrates through the bottom wall 94 of the casing 74. The communication connector 86 is connected to an external device (for example, a controller of the body 2) provided outside the propulsion drive device 16.

The drive board 87 is a gate drive board for driving the switching elements 128 (semiconductor elements) of the three power modules 77. The drive board 87 is arranged on the front side (the side of the electric motor 31) of the smoothing capacitor 79. The drive board 87 is supported by the plurality of support protrusions 156 provided in the case body 153 of the capacitor case 148 of the smoothing capacitor 79.

The control board 88 is an ECU board that controls driving of the inverter 130 (three power modules 77) via the drive board 87. The control board 88 is connected to the drive board 87 via a connector (not shown), and is also connected to the communication connector 86 via a cable (not shown). The control board 88 is held by a holding member (not shown) attached to the bottom wall 94 of the casing 74.

With reference to FIGS. 5 and 7, the heat insulation components 89, 90 include a separating member 89 and a capacitor cover 90 (an example of a partition portion). The separating member 89 and the capacitor cover 90 are formed separately. That is, the heat insulation components 89, 90 are composed of two parts. In another embodiment, the separating member 89 and the capacitor cover 90 may be formed integrally.

With reference to FIG. 5, the separating member 89 separates the internal space of the housing 36 from the internal space of the casing 74. The separating member 89 separates the rotor 39 and the stator 40 of the electric motor 31 from the electronic components E (for example, the three power modules 77, the smoothing capacitor 79, the three electric current sensors 85, the drive board 87, and the control board 88) of the controller 32. The separating member 89 is accommodated in the casing 74. In another embodiment, the separating member 89 may be accommodated in the housing 36 of the electric motor 31. The separating member 89 has a flat plate shape along a plane perpendicular to the front-and-rear direction. An axial hole 216 is formed in the central portion of the separating member 89. The extending portion 56 of the shaft 38 penetrates through the axial hole 216.

With reference to FIG. 7, the capacitor cover 90 covers the front side (one side in the front-and-rear direction), the inside in the radial direction, the outside in the radial direction, and both sides in the circumferential direction of the smoothing capacitor 79. The capacitor cover 90 separates the three power modules 77 from the smoothing capacitor 79.

### <The Fan 33>

With reference to FIGS. 3 to 5, the fan 33 is arranged on the front side (one side in the front-and-rear direction) of the electric motor 31. The fan 33 is arranged on the side opposite to the controller 32 with the electric motor 31 interposed therebetween. The fan 33 includes a cylindrical hub 223 extending in the front-and-rear direction, a cylindrical rim 224 extending in the front-and-rear direction on the outer circumference of the hub 223, and a plurality of spokes 225 extending in the radial direction and connecting the hub 223 and the rim 224. The hub 223 is fixed to the protruding portion 57 of the shaft 38 of the electric motor 31. Accordingly, the fan 33 is configured to rotate integrally with the shaft 38. A plurality of air blowing ribs 226 is provided on the outer circumferential surface of the rim 224 at intervals in the circumferential direction of the rim 224. Each air blowing rib 226 inclines forward (to one side in the front-and-rear direction) toward the downstream side in the rotational direction R of the fan 33.

### <The Duct Cover 34>

With reference to FIGS. 3 and 5, the duct cover 34 has a cylindrical shape extending in the front-and-rear direction. A cooling air passage 229 is formed between the duct cover 34 and both the housing 36 of the electric motor 31 and the circumferential wall 93 of the casing 74 of the controller 32. That is, the cooling air passage 229 is formed on the outer circumference of the housing 36 of the electric motor 31 and the casing 74 of the controller 32. The cooling air passage 229 is cylindrical and extends in the front-and-rear direction.

### <Cooling of the Electric Motor 31 and the Controller 32>

With reference to FIGS. 3 and 5, when the electric motor 31 is driven and the shaft 38 rotates, the fan 33 fixed to the protruding portion 57 of the shaft 38 rotates integrally with the shaft 38. Accordingly, the cooling air is blown by the plurality of air blowing ribs 226 of the fan 33 toward the outer circumferential surface of the housing 36 and the outer circumferential surface of the circumferential wall 93 of the casing 74. That is, the cooling air is introduced into the cooling air passage 229 by the plurality of air blowing ribs 226 of the fan 33.

The cooling air introduced into the cooling air passage 229 flows on the outer circumference of the housing 36 and between the plurality of first cooling fins 42 from the front side to the rear side. Accordingly, the electric motor 31 is cooled by the cooling air. Next, the cooling air flows on the outer circumference of the circumferential wall 93 of the casing 74 and between the plurality of second cooling fins 96 from the front side to the rear side. Accordingly, the casing 74 of the controller 32 is cooled by the cooling air. The cooling air that has passed through the outer circumference of the circumferential wall 93 of the casing 74 is discharged from the rear end of the cooling air passage 229 to the space behind the controller 32.

### <Effects>

In the present embodiment, in the air-cooled propulsion drive device 16, the heat insulation components 89, 90 separate the rotor 39 and the stator 40 of the electric motor 31 from the electronic components E (for example, three power modules 77, the smoothing capacitor 79, three electric current sensors 85, the drive board 87, and the control board 88) of the controller 32. Accordingly, it is possible to suppress the thermal influence from the plurality of coils 69 of the stator 40 of the electric motor 31 to the electronic components E of the controller 32. Accordingly, it is not necessary to greatly separate the plurality of coils 69 of the stator 40 of the electric motor 31 from the electronic components E of the controller 32 so as to suppress the thermal influence described above, so that the propulsion drive device 16 can be made smaller. Further, since it is not necessary to use highly heat-resistant devices as the electronic components E of the controller 32 in consideration of the thermal influence described above, the selection of the electronic components E of the controller 32 becomes easier. Further, the capacitor cover 90 separates the three power modules 77 of the controller 32 from the smoothing capacitor 79 thereof, so that the thermal influence from the three power modules 77 with greater heat generation to the smoothing capacitor 79 with smaller heat generation can be suppressed.

### The Second Embodiment

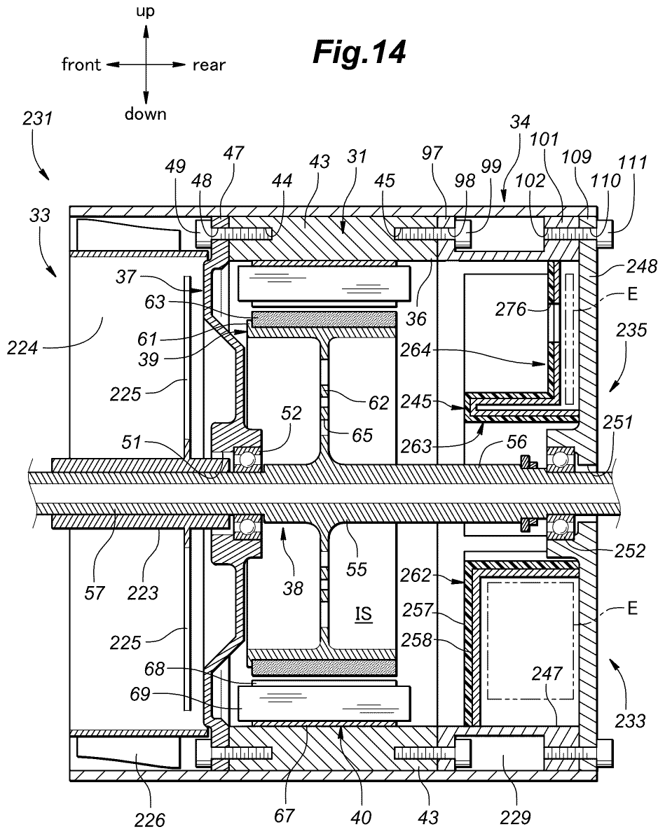

Next, with reference to FIGS. 14 to 17, a propulsion drive device 231 (an example of an electric drive device) according to the second embodiment of the present invention will be described. The components other than a controller 233 are similar to those in the first embodiment, and therefore their description will be omitted. Regarding the components of the controller 233, the same descriptions as those in the first embodiment will be omitted.

With reference to FIGS. 14 to 16, the controller 233 includes a casing 235, a resolver 236, a DC input connector 237, three power modules 238, a pressing member 239, a smoothing capacitor 240, a connection member (not shown), first and second DC bus bars 241, 242, three AC bus bars 243, three electric current sensors 244, a communication connector (not shown), a drive board (not shown), a control board (not shown), and a heat insulation component 245. Further, in FIG. 14, electronic components E (for example, the three power modules 238, the smoothing capacitor 240, the three electric current sensors 244, the drive board, and the control board) of the controller 233 are omitted, and only the outline of the electronic components E are shown. The components having the same name in the first and second embodiments (for example, the power modules 77 and the power modules 238) have the same function even if the arrangements thereof are different.

The casing 235 includes a cylindrical circumferential wall 247 extending in the front-and-rear direction on the outer circumference of the extending portion 56 of the shaft 38, and a bottom wall 248 closing the opening of the circumferential wall 247 on the rear side (the side opposite to the electric motor 31). Hereinafter, the term “circumferential direction” used in the description of the components of the controller 233 will refer to the circumferential direction of the circumferential wall 247 of the casing 235 (in other words, the circumferential direction centered on the extending portion 56 of the shaft 38), and the term “radial direction” used in the description of the components of the controller 233 will refer to the radial direction of the circumferential wall 247 of the casing 235 (in other words, the radial direction centered on the extending portion 56 of the shaft 38).

A circular through hole 251 is provided in the front-and-rear direction in the central portion of the bottom wall 248 of the casing 235. A bearing 252 is attached to the through hole 251. The extending portion 56 of the shaft 38 passes through the through hole 251. The extending portion 56 of the shaft 38 is rotatably supported by the through hole 251 via the bearing 252. The lower portion of the bottom wall 248 is provided with a ventilation hole 253 that penetrates therethrough in the front-and-rear direction and is arranged outside in the radial direction of the through hole 251.

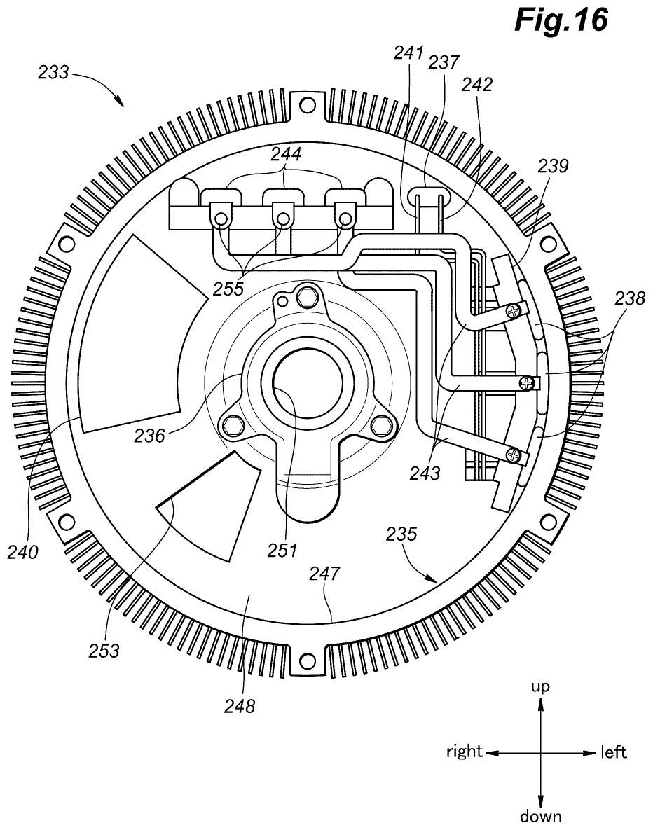

With reference to FIG. 16, the three power modules 238 are arranged at intervals in the circumferential direction and contact with the inner circumferential surface of the circumferential wall 247 of the casing 235. The three power modules 238 are arranged in the left semicircular portion (an example of one semicircular portion) of the casing 235.

The smoothing capacitor 240 is arranged on the side opposite to the three power modules 238 with the through hole 251 interposed therebetween. The smoothing capacitor 240 is arranged in the right semicircular portion (an example of the other semicircular portion) of the casing 235. The smoothing capacitor 240 is arranged at an interval from the inner circumferential surface of the circumferential wall 247 of the casing 235.

One end in the longitudinal direction of each AC bus bar 243 is connected to each power module 238. An AC output terminal 255 is provided at the other end in the longitudinal direction of each AC bus bar 243. That is, the controller 233 is provided with three AC output terminals 255.

With reference to FIG. 14, the heat insulation component 245 is accommodated in the casing 235. The heat insulation component 245 includes a resin layer 257 formed of a resin material, and a metal layer 258 formed of a metal material and provided on the resin layer 257. The resin layer 257 is arranged to face the electric motor 31 (one of the electric motor 31 and the controller 233 with greater heat generation). The metal layer 258 is arranged to face the controller 233 (one of the electric motor 31 and the controller 233 with smaller heat generation).

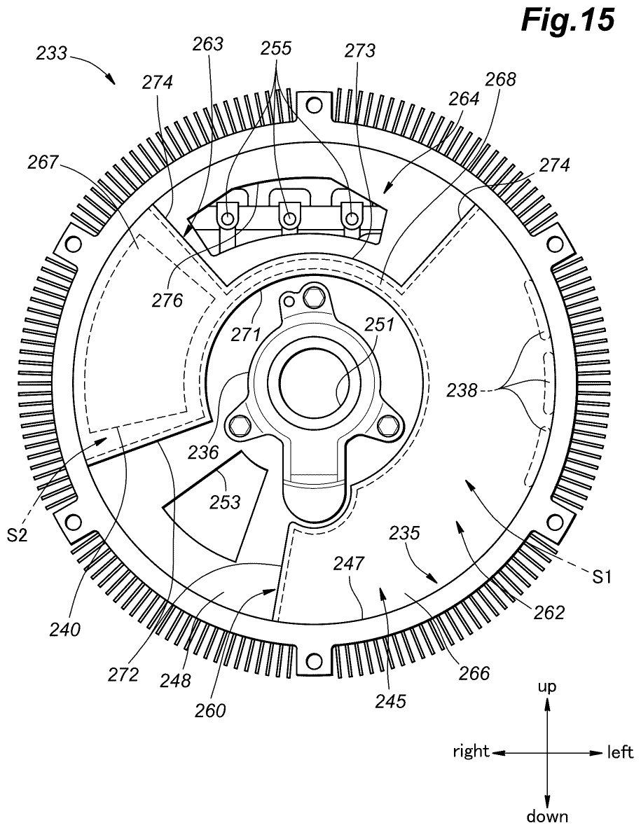

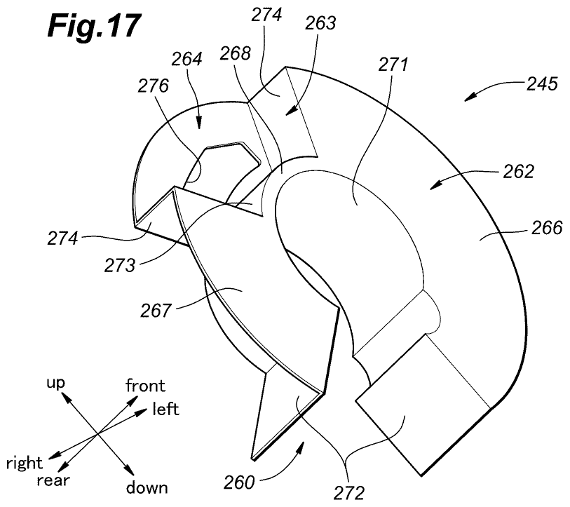

With reference to FIGS. 15 and 17, the heat insulation component 245 is curved in an arc shape along the circumferential direction. The lower portion of the heat insulation component 245 is provided with a notch 260 (a portion where the heat insulation component 245 does not exist in the circumferential direction). The notch 260 overlaps with the ventilation hole 253 of the bottom wall 248 as viewed in the front-and-rear direction. The ventilation hole 253 of the bottom wall 248 is connected to an internal space IS (see FIG. 14) of the rotor 39 via the notch 260.

With reference to FIGS. 14, 15, and 17, the heat insulation component 245 includes a flat base portion 262 provided along a plane perpendicular to the front-and-rear direction, a partition portion 263 extending along the front-and-rear direction from the base portion 262 toward the rear side (the side opposite to the electric motor 31), and a guide portion 264 bent from the rear end of the partition portion 263 and arranged along a plane perpendicular to the front-and-rear direction. The base portion 262, the partition portion 263, and the guide portion 264 are integrally formed of the same material. That is, the heat insulation component 245 is composed of one part.

The base portion 262 of the heat insulation component 245 separates the rotor 39 and the stator 40 (an example of structural components) of the electric motor 31 from the electronic components E (for example, the three power modules 238, the smoothing capacitor 240, the drive board, and the control board) of the controller 233 in the front-and-rear direction. The base portion 262 includes first and second body plates 266, 267 each having a fan shape and arranged at an interval in the circumferential direction, and a connection plate 268 having an arc shape and connecting the first body plate 266 and the second body plate 267.

The partition portion 263 of the heat insulation component 245 separates the three power modules 238 from the smoothing capacitor 240 in a direction perpendicular to the front-and-rear direction. The partition portion 263 includes a first circumferential plate 271 extending in the circumferential direction, a pair of first radial plates 272 extending from both ends of the first circumferential plate 271 in the circumferential direction toward the outside in the radial direction, a second circumferential plate 273 extending in the circumferential direction on the outside of the first circumferential plate 271 in the radial direction, and a pair of second radial plates 274 extending from both ends of the second circumferential plate 273 in the circumferential direction toward the outside in the radial direction. The length of the second circumferential plate 273 in the circumferential direction is shorter than the length of the first circumferential plate 271 in the circumferential direction.

The first circumferential plate 271, one of the first radial plates 272, and one of the second radial plates 274 of the partition portion 263 of the heat insulation component 245 and the circumferential wall 247 and the bottom wall 248 of the casing 235 define a first storage space S1 that accommodates three power modules 238. The first circumferential plate 271, the other of the first radial plates 272, and the other of the second radial plates 274 of the partition portion 263 and the circumferential wall 247 and the bottom wall 248 of the casing 235 define a second storage space S2 that accommodates the smoothing capacitor 240. Further, the second storage space S2 may accommodate not only the smoothing capacitor 240 but also the control board (not shown).

The guide portion 264 of the heat insulation component 245 is arranged parallel to the base portion 262. The guide portion 264 is provided with a terminal opening 276 that exposes the three AC output terminals 255 to the front side (to the electric motor 31).

### <Effects>

In the present embodiment, the heat insulation component 245 includes the base portion 262 provided along a plane perpendicular to the front-and-rear direction, and the partition portion 263 extending along the front-and-rear direction from the base portion 262 toward the rear side (the side opposite to the electric motor 31). The base portion 262 separates the rotor 39 and the stator 40 of the electric motor 31 from the electronic components E of the controller 233 in the front-and-rear direction, and the partition portion 263 separates the three power modules 238 from the smoothing capacitor 240 in a direction perpendicular to the front-and-rear direction. Accordingly, the heat insulation component 245 composed of a single part can suppress the thermal influence between the rotor 39 and the stator 40 of the electric motor 31 and the electronic components E of the controller 233, and the thermal influence between the three power modules 238 and the smoothing capacitor 240. Accordingly, as compared to a case where the heat insulation component 245 is composed of a plurality of parts, the configuration of the propulsion drive device 231 can be simplified.

In the above first and second embodiments, the electric motor 31 of an inner rotor type is an example of a rotary electric machine. In another embodiment, an electric motor of an outer rotor type may be an example of the rotary electric machine, or a generator may be an example of the rotary electric machine.

In the above first and second embodiments, the configuration of the present invention is applied to the propulsion drive device 16, 231. In another embodiment, the configuration of the present invention may be applied to the lift drive device 12.

In the above first and second embodiments, the configuration of the present invention is applied to an electric vertical take-off and landing aircraft. In another embodiment, the configuration of the present invention may be applied to an aircraft other than an electric vertical take-off and landing aircraft (i.e., a general aircraft that cannot take off and land vertically), or the configuration of the present invention may be applied to a mobile body other than an aircraft (for example, a vehicle such as an automobile or a motorcycle). Further, in another embodiment, the configuration of the present invention may be applied to a device that is fixedly installed.

This concludes the description of the specific embodiments, but the present invention is not limited to the above embodiments or modifications, and can be widely modified and implemented.

1. An electric drive device, comprising:
a rotary electric machine; and
a controller integrated with the rotary electric machine and configured to control driving of the rotary electric machine,
wherein the rotary electric machine includes:
a plurality of structural components; and
a housing that accommodates the plurality of structural components,
the controller includes:
a plurality of electronic components; and
a casing that is adjacent to the housing and accommodates the plurality of electronic components, and
a heat insulation component separates the plurality of structural components from the plurality of electronic components, and the heat insulation component includes a partition portion that separates the plurality of electronic components.

2. The electric drive device according to claim 1, wherein the plurality of electronic components includes:
a power module including a semiconductor element; and
a smoothing capacitor configured to smooth an electric current input to the power module, and
the heat insulation component separates the power module from the smoothing capacitor.

3. The electric drive device according to claim 2, wherein the power module contacts with an inner circumferential surface of the casing.

4. The electric drive device according to claim 2, wherein the partition portion includes:
a first circumferential plate extending in a circumferential direction;
a pair of first radial plates extending from both ends of the first circumferential plate in the circumferential direction toward an outside in a radial direction;
a second circumferential plate extending in the circumferential direction on an outside of the first circumferential plate in the radial direction; and
a pair of second radial plates extending from both ends of the second circumferential plate in the circumferential direction toward the outside in the radial direction,
the first circumferential plate, one of the first radial plates, one of the second radial plates, and the casing define a first storage space that accommodates the power module, and
the first circumferential plate, another of the first radial plates, another of the second radial plates, and the casing define a second storage space that accommodates the smoothing capacitor.

5. The electric drive device according to claim 1, wherein the casing includes:
a cylindrical circumferential wall extending in a prescribed axial direction; and
a bottom wall closing an opening of the circumferential wall on a side opposite to the rotary electric machine,
the bottom wall is provided with a ventilation hole that penetrates therethrough in the axial direction, and
the heat insulation component is provided with a notch that overlaps with the ventilation hole as viewed in the axial direction.

6. The electric drive device according to claim 5, wherein the plurality of structural components includes:
a hollow rotor; and
a stator arranged on an outer circumference of the rotor, and
the ventilation hole is connected to an internal space of the rotor via the notch.

7. The electric drive device according to claim 1, wherein the controller includes an output terminal connected to a terminal of the rotary electric machine in an internal space of the casing, and
the heat insulation component is provided with a terminal opening that exposes the output terminal to the rotary electric machine.

8. The electric drive device according to claim 1, wherein the heat insulation component includes:
a resin layer formed of a resin material; and
a metal layer formed of a metal material and provided on the resin layer, and
the resin layer is arranged to face one of the rotary electric machine and the controller with greater heat generation.

9. The electric drive device according to claim 1, wherein the rotary electric machine further includes a shaft extending in a prescribed axial direction,
the heat insulation component further includes a base portion provided along a plane perpendicular to the axial direction, and
the partition portion extends along the axial direction from the base portion toward a side opposite to the rotary electric machine.
